(19) United States
(12) Patent Application Publication
(10) Pub. No.: US 2024/0035508 A1
(43) Pub. Date: Feb. 1, 2024

(54) SCREW NUT HAVING SCREW CAGE

(71) Applicant: AUDI AG, Ingolstadt (DE)

(72) Inventor: Sebastian BAIER, Poppenhausen (DE)

(73) Assignee: AUDI AG, Ingolstadt (DE)

(21) Appl. No.: 18/256,966

(22) PCT Filed: Dec. 15, 2021
(86) PCT No.: PCT/EP2021/085816

§ 371 Date: Jun. 12, 2023

(30) Foreign Application Priority Data
Jan. 13, 2021 (DE) 102021100461.6

(51) Int. Cl. F16B 37/04; F16B 2/24

(52) U.S. Cl. CPC F16B 37/044; F16B 2/245

(57) ABSTRACT

A screw nut with a screw cage made of metal sheet, which includes a holding section securing the screw nut and a clamping section supporting the holding section. The holding section is configured with a circumferentially closed opening in which the screw nut is arranged in a rotationally fixed manner. The opening comprises multiple lugs configured as metal sheet passages which are in contact with the lateral torque transmissions surfaces of the screw nut.

### FIELD

The invention relates to a screw nut with a cage or screw cage made of metal sheet.

### BACKGROUND

From the prior art, in particular screw cages made of metal sheet are known, by means of which a screw nut can be secured in particular at inaccessible sites during tightening or loosening of the engaging screw (or the like), so that it does not rotate along with it. A unit formed by screw nut and screw cage is also referred to as cage nut.

The closest patent DE 10 2005 059 523 A1 describes a so-called flange cage nut. This flange cage nut includes a conventional flange nut (1) with a drive portion (2) which is hexagonal in top view. The flange cage nut furthermore includes a cage (3) arranged on the nut (1), which is punched out of a multiply folded metal sheet and bent. The cage (3) comprises a clamping portion (3a) and a holding portion (3b). The holding portion (3b) consists of a flat metal sheet plate with a circumferentially closed opening, in which the hexagonal drive portion (2) of the nut (1) sits with precise fit and in a rotationally fixed manner.

Concerning the prior art, reference is furthermore made to the patents WO 2012/156271 A9, DE 10 2011 000 660 A1 and DE 691 00 071 T2.

### SUMMARY

In the screw nut with screw cage according to the invention, the screw cage is configured so that high holding forces or high counter (holding) torques can be exerted onto the screw nut. Additional features of the invention result from the dependent claims, from the following description of the invention (wherein this explicitly also includes features described as “for example,” “preferably,” “in particular,” etc.) and from the drawing.

The invention provides a screw nut, in particular a metallic screw nut, with a screw cage made of metal sheet (thereby meaning a unit or connection consisting of screw nut and screw cage, which can also be designated as cage nut). The screw cage comprises a holding section (holding portion) securing the screw nut and a clamping section (clamping portion) supporting the holding section (for example, against a body portion). The holding section is configured with a circumferentially closed opening in which the screw nut is arranged in a rotationally fixed manner or which encompasses the screw nut in a rotationally fixed manner According to the invention, it is provided that the opening in the holding section of the screw cage comprises multiple lugs configured as metal sheet passages, in particular tongue-like lugs, which are in contact with the (outer) lateral torque transmission surfaces or tool contact surfaces of the screw nut.

The lugs configured as sheet metal passages are arranged on the inner margin of the opening and extend in particular at least partially in axial direction of the screw nut and therefore can also be referred to as erect lugs. Preferably, the lugs are arranged uniformly distributed in circumferential direction, wherein one tab is provided in particular for each torque transmission surface of the screw nut. Preferably the screw nut is a square or hexagonal nut or the like, in particular a hexagonal flange nut, wherein, preferably for each of the torque transmission surfaces on the screw nut, that is to say for all four or six torque transmission surfaces, a respective tab is provided on the screw cage. However, a tab can also be provided only for every other torque transmission surface of the screw nut.

Due to a clamping effect, the lugs bring about very high holding forces, for the axial fixation of the screw nut in the screw cage and also facilitate the exertion of counter-torques (for torque anchoring) onto the screw nut. Due to the flat physical contact between the lugs and the screw nut, the scratch and chip formation during the premounting (i.e., during the insertion of the screw nut into the opening of the screw cage) are reduced, in particular on a coated screw nut (see below). Thereby the risk of subsequent corrosion is also reduced.

Preferably, the opening (in the holding section of the screw cage) at least in sections is configured to be larger than the screw nut. Therefore, the screw nut does not sit with precise fit in the opening, but instead, between the two, a gap is present at least in the sections concerned, which allows a small space for movement (play). This gap or space for movement facilitates the premounting and reduces the scratch and chip formation. The gap preferably has a width of at most a few tenths of a millimeter.

The screw nut can comprise a coating, in particular a corrosion protection coating (for example, a zinc coating). A scratching or abrasion of this coating can be largely prevented by the above-described measures (flat physical contact of the lugs and/or gap or space for movement).

Preferably, the opening (in the holding section of the screw cage) is configured with additional positive locking elements which abut against or engage in the edge regions between the torque transmission surfaces on the screw nut, optionally with a gap or play (see above). Preferably, for each edge or optionally also only for every other edge of the screw nut, an additional positive locking element is provided. The number of lugs and additional positive locking elements can be different, wherein preferably the same number of lugs and additional positive locking elements each arranged between the lugs is provided (for example, six lugs and six additional positive locking elements). Preferably the additional positive locking elements protrude from the opening margin in direction of the screw nut and extend in particular in the plane of the holding section. The additional positive locking elements enable the transmission of very high torques or counter-torques (for torque anchoring).

In particular, a functional separation is provided in such a manner that the lugs are substantially provided for the axial fixation of the screw nut in the screw cage and the additional positive locking elements are substantially provided for torque anchoring. During the tightening or loosening of a screw engaging in the screw nut, the lugs can be resiliently deformed, so that the torque anchoring can substantially occur only via the additional positive locking elements.

Preferably, the additional positive locking elements are configured fork-like on their ends facing the screw nut, in particular in each case with two jags or prongs which respectively lie or engage on both sides next to the edges (which are configured between the torque transmission surfaces) of the screw nut. Preferably, the inner regions of these fork-like ends, thereby meaning in particular the regions between the two jags or prongs, are rounded or configured with rounded portions to reduce notch effects and in particular to prevent notch stress.

The screw nut is preferably configured with an M10, M12 or M14 (or higher) internal thread. Thus, occasionally, comparatively high tightening and loosening torques are provided, which can be supported by means of the screw cage.

The screw cage is preferably configured as a one-piece metal sheet part (punched formed portion) and produced in particular from a spring steel metal sheet. The metal sheet preferably has a thickness of 1.0 mm to 1.5 mm.

### BRIEF DESCRIPTION OF THE FIGURES

The invention is explained in further detail below in a nonlimiting manner in reference to two embodiment examples shown in the drawing. The features shown in the figures and/or explained below can be general features of the invention, including independently of certain combinations of features, and accordingly develop the invention. Furthermore, the features of the embodiment examples can also be combined with one another.

FIG. 1 shows, in two separate representations, a first embodiment example of a screw nut according to the invention with a screw cage.

FIG. 2 shows a second embodiment example of a screw nut according to the invention with a screw cage.

### DETAILED DESCRIPTION

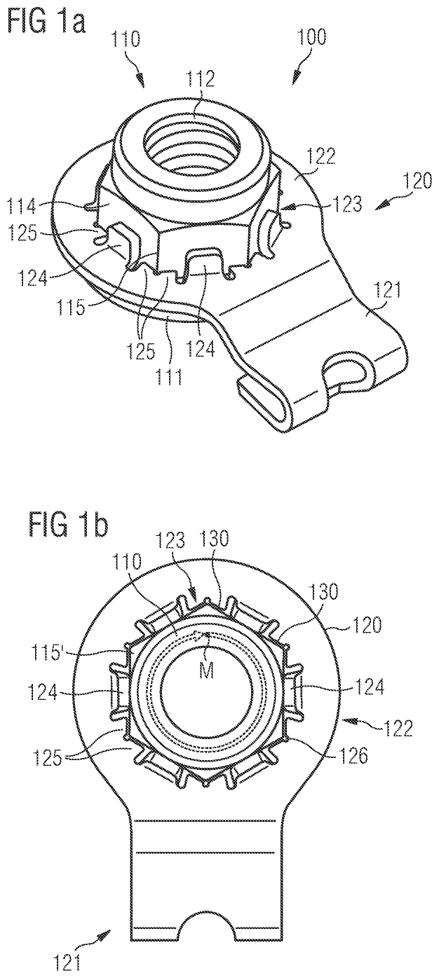

In FIG. 1, the screw nut 110 is configured for example as a hexagonal nut with a flange 111 (so-called hexagonal flange nut) and a plastic insert 112 serving as a loss prevention device (so-called lock nut). The screw cage 120 configured as a one-piece metal sheet part comprises a flat holding section 122 securing the screw nut 110 and a clamping section (clamping spring) 121 supporting the holding section 122. The holding section 122 is configured with a circumferentially closed opening 123 in which the screw nut 110 sits in a rotationally fixed manner The opening 123 can also have a different contour. The premounted unit (cage nut) consisting of screw nut 110 and screw cage 120 has the reference numeral 100.

The opening 123 in the holding section 122 of the screw cage 120 is configured in sections to be larger than the screw nut 110, so that in the corresponding sections between the two a gap 130 is present, as indicated in the top view of FIG. 1b. The gap 130 allows a small space for movement between the screw nut 110 and the screw cage 120.

The opening 123 comprises multiple lugs 124 configured as more or less collar-like, which are configured as metal sheet passages or erect in axial direction, and which are in contact with the outer torque transmission surfaces 114 of the screw nut 110 and fixedly clamp the screw nut 110 between them. As can be seen in the top view of FIG. 1b, the lugs 124 are cut free on both sides, so that they are better able to flex in radial direction.

The opening 123 is furthermore configured with additional positive locking elements 125 which are arranged between the lugs 124 and which abut against the edges 115 or lie in the edge regions 115′ of the screw nut 110. The additional positive locking elements 125 are configured fork-like. The V-shaped inner regions on the fork-like ends comprise rounded portions 126 in order to prevent notch stresses. In the unloaded or torque-free state, the additional positive locking elements 125 are spaced apart by the gap 130 (see above) from the screw nut 110.

As already explained above, the lugs 124 are essentially provided for the axial fixation of the screw nut 110, and the additional positive locking elements 125 are essentially provided for torque anchoring. During the tightening or loosening of a screw engaging in the screw nut 110, a torque M (see FIG. 1b) is exerted on the screw nut 110, whereby first the lugs 124 are elastically deformed, until the play due to the gap between the screw nut 110 and the screw cage 120 is overcome, and a torque anchoring can then occur via the additional positive locking elements 125.

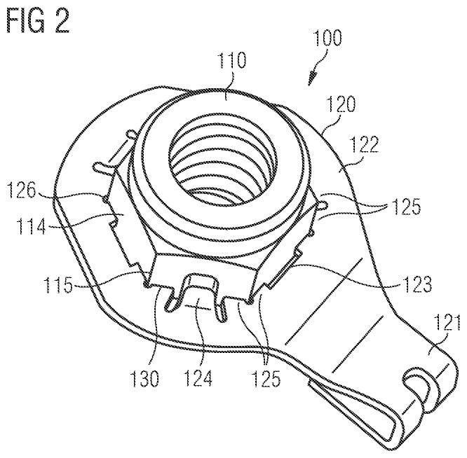

The embodiment example shown in FIG. 2 differs from the embodiment example shown in FIG. 1 essentially in that the screw nut 110 and the holding section 122 of the screw cage 120 have a different relative orientation and in that only three lugs 124 are provided, which are in contact with every other torque transmission surface 114 of the screw nut 110. Nonetheless, analogously to the embodiment example of FIG. 1, six additional positive locking elements 125 are provided in all, so that a counter-torque of substantially identical value can be exerted onto the screw nut 110. The opening 123 can also have a different contour.

1-10. (canceled)

11. A screw nut with a screw cage made of metal sheet, which comprises a holding section securing the screw nut and a clamping section supporting the holding section, wherein the holding section is configured with a circumferentially closed opening in which the screw nut is arranged in a rotationally fixed manner, wherein the opening comprises multiple lugs configured as metal sheet passages which are in contact with the lateral torque transmissions surfaces of the screw nut, wherein the lugs bring about an axial fixation of the screw nut in the screw cage by clamping effect.

12. The screw nut with screw cage according to claim 11, wherein the screw nut is configured as square or hexagonal nut, wherein one tab is provided for each torque transmission surface of the screw nut.

13. The screw nut with screw cage according to claim 11, wherein the screw nut is configured as square or hexagonal nut, wherein one tab is provided only for every other torque transmission surface of the screw nut.

14. The screw nut with screw cage according to claim 11, wherein the opening is configured in sections to be larger than the screw nut, so that a gap is present between the two, in the sections concerned.

15. The screw nut with screw cage according wo claim 11, wherein the screw nut comprises a coating.

16. The screw nut with screw cage according to claim 11, wherein the opening is configured with additional positive locking elements which are in contact with the screw nut in the edge regions between the torque transmission surfaces, wherein the additional positive locking elements are provided for torque anchoring.

17. The screw nut with screw cage according to claim 16, wherein the additional positive locking elements are configured fork-like on their ends facing the screw nut.

18. The screw nut with screw cage according to claim 17, wherein the inner regions of the fork-like ends are configured with rounded portions.

19. The screw nut with screw cage according to claim 11, wherein the screw nut is provided with an M10, M12 or M14 internal thread.

20. The screw nut with screw cage according to claim 11, wherein the screw cage is made as a one-piece metal sheet part.

21. The screw nut with screw cage according to claim 12, wherein the opening is configured in sections to be larger than the screw nut, so that a gap is present between the two, in the sections concerned.

22. The screw nut with screw cage according to claim 13, wherein the opening is configured in sections to be larger than the screw nut, so that a gap is present between the two, in the sections concerned.

23. The screw nut with screw cage according wo claim 12, wherein the screw nut (110) comprises a coating.

24. The screw nut with screw cage according wo claim 13, wherein the screw nut comprises a coating.

25. The screw nut with screw cage according wo claim 14, wherein the screw nut comprises a coating.

26. The screw nut with screw cage according to claim 12, wherein the opening is configured with additional positive locking elements which are in contact with the screw nut in the edge regions between the torque transmission surfaces, wherein the additional positive locking elements are provided for torque anchoring.

27. The screw nut with screw cage according to claim 13, wherein the opening is configured with additional positive locking elements which are in contact with the screw nut in the edge regions between the torque transmission surfaces, wherein the additional positive locking elements are provided for torque anchoring.

28. The screw nut with screw cage according to claim 14, wherein the opening is configured with additional positive locking elements which are in contact with the screw nut in the edge regions between the torque transmission surfaces, wherein the additional positive locking elements are provided for torque anchoring.

29. The screw nut with screw cage according to claim 15, wherein the opening is configured with additional positive locking elements which are in contact with the screw nut in the edge regions between the torque transmission surfaces, wherein the additional positive locking elements are provided for torque anchoring.

30. The screw nut with screw cage according to claim 12, wherein the screw nut is provided with an M10, M12 or M14 internal thread.
